(19) United States
(12) Patent Application Publication
(10) Pub. No.: US 2022/0337091 A1
(43) Pub. Date: Oct. 20, 2022

(54) Method for Operating a Wireless Charger and a Wireless Charger System

(71) Applicant: TDK Electronics AG, Munich (DE)

(72) Inventors: Jacek Tomasik, Oftringen (CH); Hugh Hemphill, Solothurn (CH)

(21) Appl. No.: 17/634,513

(22) PCT Filed: Sep. 9, 2020
(86) PCT No.: PCT/EP2020/075205

§ 371 Date: Feb. 10, 2022

(30) Foreign Application Priority Data
Sep. 12, 2019 (DE) 102019124568.0

(51) Int. Cl. H02J 50/12; B60L 53/12; H02J 50/80; H02J 7/00; H02M 1/12; H02M 7/483; H02J 7/02

(52) U.S. Cl. CPC H02J 50/12; B60L 53/12; H02J 50/80; H02J 7/00034; H02M 1/12; H02M 7/483; H02J 7/02

(57) ABSTRACT

In an embodiment a method for operating a wireless charger includes providing a set of parameter records, assigning parameter records of the set of parameter records to individual converters and generating and providing, for each converter depending on an assigned parameter record, a control signal vector so that a multi-level converter arrangement including the converters provides a supply power with a desired signal waveform to a power source resonator, wherein the parameter records depend on the desired signal waveform of the multi-level converter arrangement, wherein each parameter record defines a duty-cycle and/or a phase shift angle of the converter output signal, and wherein the duty-cycles and/or the phase shift angles of at least two parameter records are different.

This patent application is a national phase filing under section 371 of PCT/EP2020/075205, filed Sep. 9, 2020, which claims the priority of German patent application 102019124568.0, filed Sep. 12, 2019, each of which is incorporated herein by reference in its entirety.

### TECHNICAL FIELD

The present disclosure relates to a method and a corresponding apparatus for operating a wireless charger. The present disclosure also relates to a wireless charger system and wireless power transfer system. The wireless charger is in particular configured to charge a battery of an electrically driven vehicle.

### BACKGROUND

Wireless power transfer (WPT) for electrical vehicles is a contactless inductive energy transfer system. At present such systems operate with a fundamental frequency range between 79 kHz and 90 kHz as specified by international standard agencies. The magnetic field generated in wireless power transfer has a stray field component which radiates into a surrounding area and is a potential source of radio interference.

The electrical current which generates the magnetic field is itself not a perfect sine wave, and as such contains harmonics of the fundamental frequency. These harmonics fall directly in the Long Wave and Medium Wave bands used by licensed transmitters, which is of great concern to radio users and the International Telecommunications Union, ITU, who fear that radio services will be severely disrupted when wireless chargers are operating in the vicinity of radio receivers.

For solving this problem US Patent Application No. 2015/0145341 A1 discloses a shaping of the magnetic field using magnetic topologies which have reduced stray field emissions.

### SUMMARY OF THE INVENTION

Embodiments provide a method and a corresponding apparatus for operating a wireless charger allowing for reducing an emitted magnetic stray field of the wireless charger and/or allowing for an improved efficiency of the wireless charger.

Further embodiments provide a wireless charger system with reduced magnetic stray field emission and improved efficiency.

Yet other embodiments provide a wireless power transfer system with reduced magnetic stray field emission and improved efficiency.

In a first and second aspect of the present disclosure, a method and an apparatus for operating a wireless charger are presented. The wireless charger comprises a multi-level converter arrangement with a first converter and at least one further converter. Each converter is configured to receive a respective control signal vector and to provide a pulse-width-modulated, pwm, output signal on its output terminals dependent on the received control signal vector. Furthermore the wireless charger comprises a power source resonator for wirelessly transmitting power to a power capture resonator. The multi-level converter arrangement is configured to provide a supply power to the power source resonator. A set of parameter records is provided and the parameter records are assigned to the individual converters. For each converter a control signal vector is generated and provided dependent on the assigned parameter record, so that the multi-level converter arrangement provides the supply power with a desired signal waveform to the power source resonator. The set of parameter records depends on the desired signal waveform of the multi-level converter arrangement. Each parameter record defines a duty-cycle and/or a phase shift angle of a converter output signal of the assigned converter and the duty-cycles and/or phase shift angles of at least two parameter records are different.

Advantageously the output voltage of the multi-level converter arrangement, i.e. the driving voltage of the wireless charging power source, has more levels and takes on a shape which is more sinusoidal, as a result of which the wave fidelity is improved and the harmonic content decreased. The shaping of the output of the multi-level converter arrangement results in a current waveform in the wireless charging coils which is very close to being a sine wave, thereby reducing the stray fields at harmonic frequencies and subsequently reducing or eliminating radio frequency interference. Furthermore not only the stray field harmonics are reduced, but also an increase in overall efficiency can be achieved, most likely due to a reduction in copper and iron losses caused by higher frequency harmonics which have been eliminated. The parameter records of the converters can be selected or determined such that an output signal of the first converter and an output signal of the at least one further converter, comprise a respective phase angle such that selected harmonics and/or total distortion are minimal.

According to embodiments of the first and second aspects, the assignment of parameter records to the converters varies over time. Advantageously this allows for loss balancing. An even distribution of the losses in the converters can be achieved.

According to embodiments of the first and second aspects, for a multi-level converter with more than three levels the assignment of the parameter records changes after every pulse-width-modulation cycle.

According to embodiments of the first and second aspects, at least one converter comprises a switching unit with two half-bridge modules and each parameter record defines a duty-cycle for the respective half-bridge modules of the converter, wherein the duty-cycles of the half-bridge modules are different. Alternatively or additionally each parameter record defines a phase shift angle for the respective half-bridge modules of the converter, wherein the phase shift angles of the half-bridge modules are different. The generic phase shifted PWM modulation method for N-level resonant converters is able to optimize harmonics by controlling M=(N−1)/2 number of for example bridge converters supplied for instance by a single Power Factor Correction converter (buck/boost) and for instance decoupled by isolation transformer(s).

According to embodiments of the first and second aspects, a switching frequency of the converters is controlled such that the output voltage of the multi-level converter comprises a fundamental frequency between 79 kHz and 90 kHz, according to which the wireless charging current has a fundamental frequency between 79 kHz and 90 kHz, which is the preferred frequency range for wireless power transfer for electric vehicles.

According to embodiments of the first and second aspects the parameter records of the converters are selected or determined based on a Fourier's series optimization with minimizing selected harmonics and/or minimizing total distortion as criterion for optimization. The parameter records of the converters are selected or determined such that an output signal of the first converter and an output signal of the at least one further converter, comprise a respective phase angle such that selected harmonics and/or total distortion are minimal.

In a third aspect of the present disclosure, a wireless charger system is presented. The wireless charger system comprises an apparatus according to the second aspect or an advantageous embodiment of the apparatus according to the second aspect. The wireless charger system furthermore comprises a wireless charger comprising a multi-level converter arrangement with a first converter and at least one further converter, each converter being configured to receive a respective control signal vector and to provide a pulse-width-modulated, pwm, output signal on its output terminals dependent on the received control signal vector. Furthermore the wireless charger comprises a power source resonator for wirelessly transmitting power to a power capture resonator.

According to embodiments of the third aspect, the multi-level converter arrangement comprises N levels and M converters, wherein N is a positive integer greater than 3 or equal to 3, and M=(N−1)/2. Compared to conventional three-level modulation, more degrees of freedom in five-level modulation or even higher, allow a reduction of distortion in the converter output voltage and current. Consecutively, the 3rd harmonic, the 5th harmonic, and/or the 9th harmonic, respectively, can be reduced in the electromagnetic field.

According to embodiments of the third aspect, the multi-level converter arrangement comprises K isolation transformers, wherein K=M−1. The presence of isolation transformers allows that there is no commutation fault between the series-connected cells and additionally, it improves the EMC performance of the whole WPT system.

According to embodiments of the third aspect, the isolation transformers are arranged between the multi-level converter arrangement and the power source resonator.

According to embodiments of the third aspect, the wireless charger comprises a power correction module which is configured to supply a direct voltage to the at least two converters. Advantageously, a power factor correction is maintained. The power factor correction module has two functions, firstly to shape the grid current to near unity power factor and secondly, to provide a stable DC voltage input to the converter.

In a fourth aspect of the present disclosure, a wireless power transfer system is presented. The wireless power transfer system comprises a wireless charger system according to the third aspect or an advantageous embodiment of the wireless charger system according to the third aspect. Furthermore, the wireless power transfer system comprises a power capture resonator as well as a rectifier. The rectifier is configured to be coupled to a load.

### BRIEF DESCRIPTION OF THE DRAWINGS

It is to be understood that both the foregoing general description and the following detailed description are merely exemplary, and are intended to provide an overview or framework to understand the nature and character of the claims. The accompanying drawings are included to provide a further understanding and are incorporated in, and constitute a part of, this description. The drawings illustrate one or more embodiments, and together with the description serve to explain principles and operation of the various embodiments. The same elements in different figures of the drawings are denoted by the same reference signs.

The drawings are not necessarily drawn to scale but are configured to clearly illustrate the disclosure.

FIG. 1 shows a block diagram of an exemplary embodiment of a wireless charger;

FIG. 2 shows a block diagram of an exemplary embodiment of a switch unit;

FIG. 3 shows a block diagram of an exemplary embodiment of a 3-level converter with its control signals;

FIG. 4 shows an exemplary flow chart for a program to operate a wireless charger;

FIGS. 5a to 5c show exemplary traces of an output signal of the multi-level converter arrangement and its first converter and a second converter;

FIG. 6 show exemplary traces of switch pulses applied to switches of the first converter and the second converter; and

FIGS. 7a to 7c show exemplary voltage output traces and current output traces of respective multi-level converter arrangements as well as the corresponding spectral analysis.

### DETAILED DESCRIPTION OF EMBODIMENTS

The present disclosure will now be described in greater detail hereinafter with reference to the accompanying drawings showing embodiments of the disclosure. The disclosure may, however, be embodied in many different forms and should not be construed as limited to the embodiments set forth herein. Rather, these embodiments are provided so that the disclosure will fully convey the scope of the disclosure to those skilled in the art. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

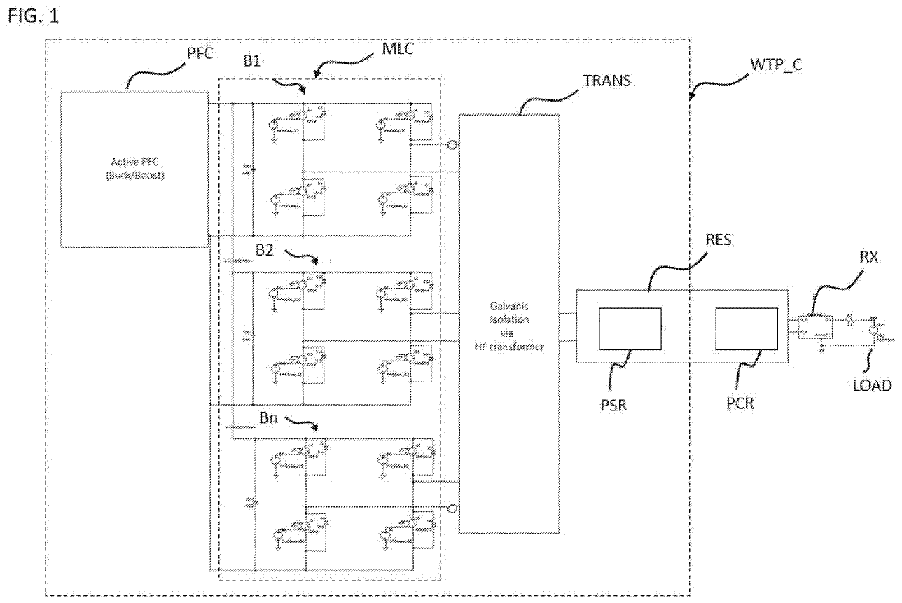

FIG. 1 shows a block diagram of a wireless power transfer system. The wireless power transfer system comprises a multi-level converter arrangement, a wireless power transfer (WPT) resonance circuit, a rectifier and a load and a control unit (not shown in FIG. 1). The WPT resonance circuit RES comprises a power source resonator and a power capture resonator. The wireless multi-level converter arrangement and the power source resonator are part of a wireless charger. The power capture resonator, the rectifier and the load are preferably arranged in an electrically driven vehicle. The wireless charger is preferably arranged stationary.

In an optional embodiment the wireless charger comprises a single and/or a three phase power factor correction module, which is configured to provide a direct voltage to the converters of the multi-level converter arrangement. The power factor correction module is in particular configured to shape a grid current to near unity power factor and to provide a stable DC voltage input to the converters. Instead of the term “grid current” also the term “phase current” can be used. In a single-phase grid or a star-connected three-phase grid the grid current and a line current are equal.

The multi-level converter arrangement is configured to provide an output voltage Vcon, which is used to supply power to the wireless power transfer (WPT) resonance circuit.

The multi-level converter arrangement comprises output terminals OUT1, OUT2 adapted to provide an AC output voltage Vcon, and a plurality of at least two converters. In the present example the multi-level converter arrangement includes three converters C1, C2, Cn. However, this is only an example. It goes without saying that any number higher than one of converters can be provided.

Each of the converters C1, C2, Cn is adapted to produce an output voltage V1, V2, Vn that can assume one of three different voltage levels. Assuming that the converter stages C1 to Cn receive identical input voltages, these three different voltage levels are: +V′, −V′, or 0 (zero).

In general, a multi-level converter arrangement having a number of n converters can produce 2n+1 different voltage levels of the output voltage Vcon, where these different voltage levels range from −n·V′ over 0 (zero) to +n·V′.

Each converter comprises a first input converter terminal and a second input converter terminal and a first output converter terminal P1, P2, Pn and a second output converter terminal Q1, Q2, Qn. Furthermore each converter comprises a switch unit B1, B2, Bn.

The respective switch units B1, B2, Bn are arranged between the respective converter input terminals and the respective converter output terminals P1, Q1, P2, Q2, Pn, Qn.

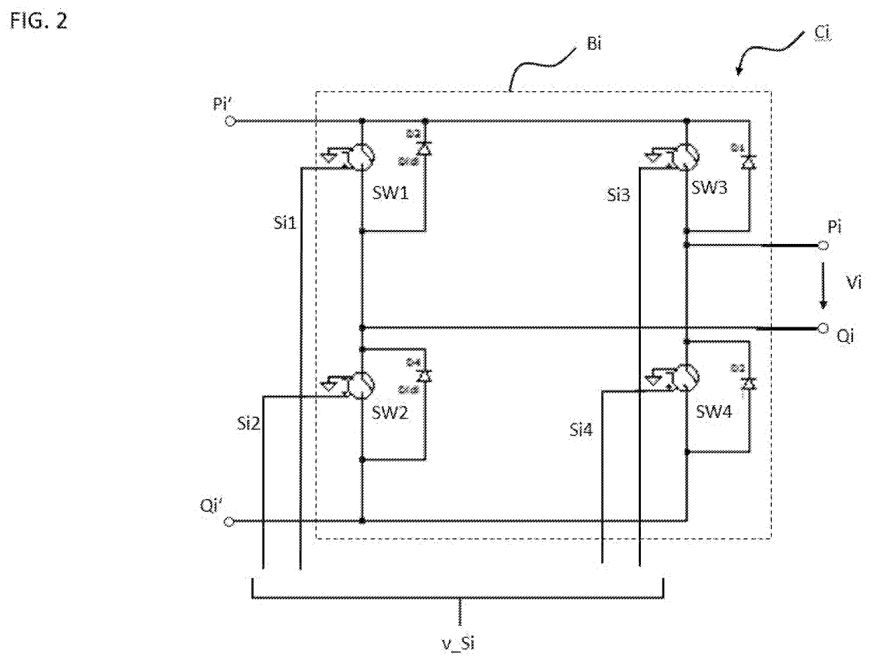

FIG. 2 shows an example of such a switch unit B1, B2, Bn. The respective switch units B1, B2, Bn comprise for instance four switches SW1, SW2, SW3, SW4 that form an H-bridge connected between the input terminals Pi′, Qi′ and the output terminals Pi, Qi, wherein i=1, 2, . . . , n and n is the number of converters of the multi-level converter arrangement.

The switches SW1, SW2, SW3, SW4 are, for example, implemented as semiconductor switches, such as bipolar or field-effect transistors.

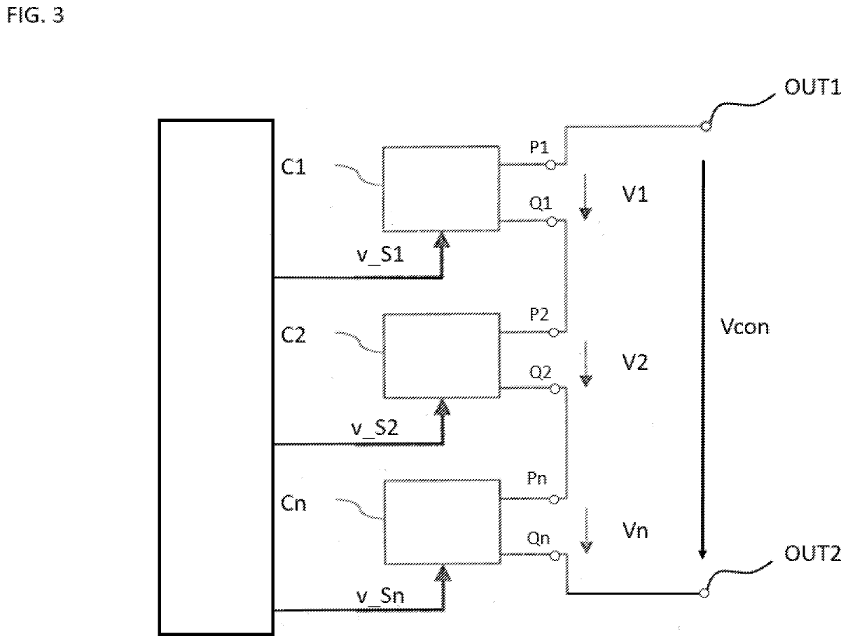

FIG. 3 shows a multi-level converter arrangement MLC with 3 converters C1, C2, Cn with its control signal vectors v_S1, v_S2, v_Sn.

For controlling the switch units B1, B2, Bn each switch unit B1, B2, Bn is configured to receive respective control signals. In particular each switch unit B1, B2, Bn is configured to receive a group or vector of control signals. Preferably such a control signal vector v_S1, v_S2, v_Sn comprises four control signals, for example v_Si=(Si1, Si2, Si3, Si4) as shown in FIG. 2.

As shown in FIG. 3 each converter C1, C2, Cn is configured to provide a pulse-width modulated output voltage V1, V2, Vn at its output terminals P1, Q1, P2, Q2, Pn, Qn, wherein a duty-cycle of each of these output voltages V1, V2, Vn depends on the received control signal vector v_S1, v_S2, v_Sn.

The multi-level converter arrangement MLC is configured to provide the output voltage Vcon, which is the sum of the pulse-width modulated output voltage V1, V2, Vn of the converters C1, C2, Cn.

For this, one of the converters C1, C2, Cn, such as the first converter stage C1, has a first output terminal P1 connected to the first output terminal OUT1; one of the converters C1, C2, Cn, such as the third converter stage Cn, has a second output terminal Qn connected to the second output terminal OUT2; and the other converter stages, such as the second converter C2, have their first output terminals P2, Pn connected to the second output terminals Q1, Qn−1 of another converter.

The control signals of the control signal vectors v_S1, v_S2, v_Sn are provided by the control unit, which can also be named apparatus for operating a wireless charger. The control unit is adapted to generate the control signals of the control signal vectors v_S1, v_S2, v_Sn for example such that the output voltage Vcon is an oscillating voltage. The output voltage Vcon is the sum of the individual output voltages V1, V2, Vn of the individual converters C1, C2, Cn.

By selecting a suitable time sequence of the individual voltage levels of the different converters C1, C2, Cn the output voltage Vcon of the multi-level converter arrangement can approximate a time-continuous signal, in particular a continuous oscillating signal, such as a signal having a sinusoidal wave form.

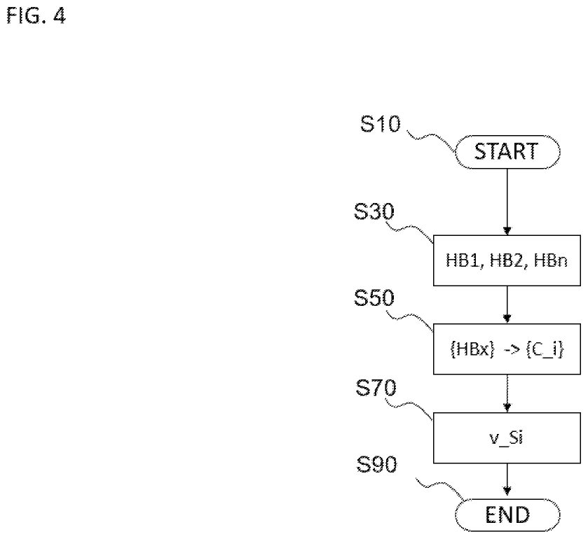

FIG. 4 shows an exemplary flow chart for a program for operating a wireless charger. The program may be executed by the control unit.

In a step S10 the program is started. During starting the program variables and/or objects may be initialized.

In a step S30 a set of parameter records HB1, HB2, HBn are provided, wherein the set of parameter records HB1, HB2, HBn depends on a desired output voltage waveform of the multi-level converter arrangement MLC.

Each parameter record HB1, HB2, HBn defines a duty-cycle and/or a phase shift angle S of a converter output signal V1, V2, Vn, and the duty-cycles and/or phase shift angles S of at least two parameter records HB1, HB2, HBn are different.

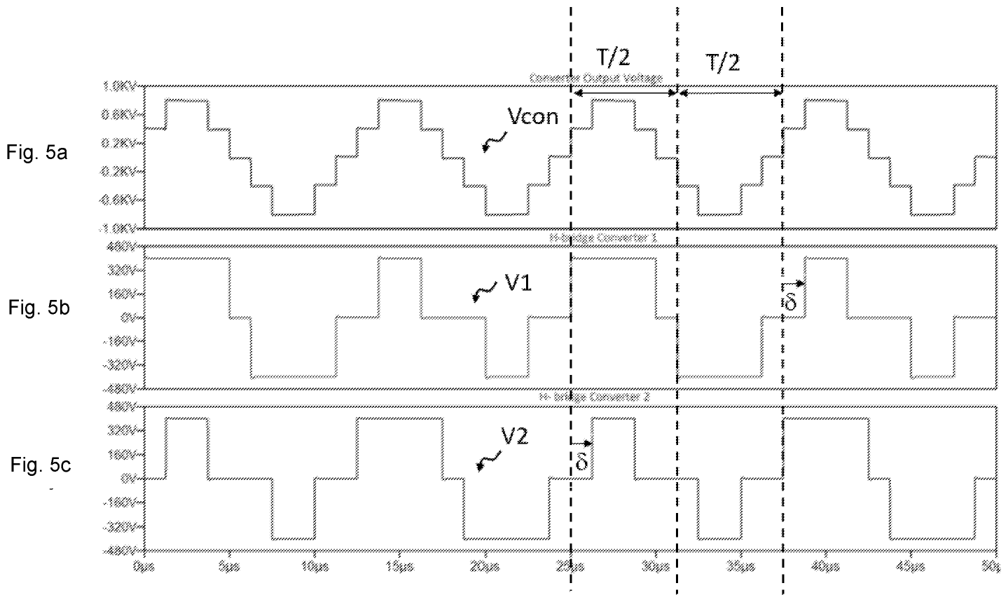

In the embodiment illustrated in FIG. 5a the output voltage Vcon of the multi-level converter arrangement MLC that is to be approximated is a sinusoidal voltage. A sinusoidal voltage has two half-cycles: a positive half-cycle, and a negative half-cycle, each having a time period T/2. Preferably a pulse-width-modulation duty-cycle is equal to the period length of the to-be-approximated periodic voltage.

In the embodiment of FIGS. 5a to 5c two converters are used to provide the output voltage Vcon of the multi-level converter arrangement MLC.

FIG. 5b shows an exemplary trace of the output voltage V1 of a first converter C1, and FIG. 5c shows an exemplary trace of the output voltage V2 of a second converter C2.

The sinusoidal signal waveform is obtained by superimposing the output voltages V1-Vn of the individual converters C1, C2, Cn, for example by superimposing the output voltages V1, V2 of the first and second converters C1, C2. Generation of the sinusoidal output voltage Vcon during the positive half-cycle will now be explained. Generation of the output signal Vcon during the negative half-cycle is equivalent to the difference that the output voltages V1-Vn of the converter stages are positive voltages during the positive half cycle, and are negative voltages during the negative half-cycle.

The duty-cycles of the individual output voltages V1-Vn are set by the control circuit via the control signal vectors v_S1, v_S2 and v_Sn. Referring to the explanation hereinabove the output voltages V1, V2, Vn of the converter stages C1, C2, Cn that are superposed to generate the output voltage Vcon are each defined by a parameter record that, besides others (such as switch-on and switch-off times), defines the duty cycle and/or phase shift angles S of the output voltages V1, V2, Vn. Given a desired output voltage, and given a number of converter stages, the control circuit is configured to provide a set of parameter records HB1, HB2, HBn with a number of parameter records being equal to the number of converters C1, C2, Cn. These parameter records may, for example, be provided by calculating, or by reading stored parameter record values from a storage device.

Further, given a particular parameter record set for a given converter, for example for the first converter, the control unit is adapted to generate the control signal vector v_S1 of the converter C1 such that the first converter C1 generates the output voltage V1 in accordance with the assigned parameter record HBx, which is selected from the set of parameter records.

In a step S50 the parameter records HB1, HB2, HBn are assigned to the individual converters C1, C2, Cn.

In an optional embodiment the assignment of parameter records HB1, HB2, HBn to the converters C1, C2, Cn varies over time.

Table 1 shows for different converter levels how the assignment of the parameter records HB1, HB2, HBn may vary. In Table 1 HB1 represents a first parameter record and HB2 represents a second parameter record, etc. For each converter level each line of Table 1 from the third column corresponds to one converter. Thus, for a multi-level converter arrangement with five levels during a first pulse-width-modulation cycle the first converter is assigned the first parameter record HB1 and in a second pulse-width-modulation cycle the second parameter record HB2. Furthermore, in the first pulse-width-modulation cycle the second converter is assigned the second parameter record HB2 and in the second pulse-width-modulation cycle the first parameter record HB1. For the further pulse-width-modulation cycle this scheme is repeated.

TABLE 1
Assignment of parameter records to converters

| Converter | | PWM | PWM | PWM | PWM | | PWM cycie |
|---|---|---|---|---|---|---|---|
| level (odd | | 1st cycle | 2nd cycle | 3rd cycle | 4th cycle | . . . | nth cycle |
| number) | HB No. | Number of H-bridge converter in active state over PWM cycle | | | | | |
| 3 | Number of | HB1 | | | | | |
| 5 | H-bridge | HB1 | HB2 | | | | |
| | converter in | HB2 | HB1 | | | | |
| 7 | active state | HB1 | HB2 | HB3 | | | |
| | over PWM | HB2 | HB3 | HB1 | | | |
| | cycle | HB3 | HB1 | HB2 | | | |
| 9 | | HB1 | HB2 | HB3 | HB4 | | |
| | | HB2 | HB3 | HB4 | HB1 | | |
| | | HB3 | HB4 | HB1 | HB2 | | |
| | | HB4 | HB1 | HB2 | HB3 | | |
| 11 | | HB1 | HB2 | HB3 | HB4 | HB5 | |
| | | HB2 | HB3 | HB4 | HB5 | HB1 | |
| | | HB3 | HB4 | HB5 | HB1 | HB2 | |
| | | HB4 | HB5 | HB1 | HB2 | HB3 | |
| | | HB5 | HB1 | HB2 | HB3 | HB4 | |
| N | | HB1 | HB2 | HB3 | HB4 | . . . | HB (N − 1)/2 |
| | | HB2 | HB3 | HB4 | . . . | HB (N − 1)/2 | HB1 |
| | | HB3 | HB4 | . . . | HB (N − 1)/2 | HB1 | HB2 |
| | | HB4 | . . . | HB (N − 1)/2 | HB1 | HB2 | HB3 |
| | | . . . | HB (N − 1)/2 | HB1 | HB2 | HB3 | . . . |
| | | HB (N − 1)/2 | HB1 | HB2 | HB3 | . . . | HB (N − 3)/2 |

In a step S70 the control signals of the control signal vectors v_S1, v_S2, v_Sn are generated such that the output signals V1, V2, Vn of the converters C1, C2, Cn, in particular the output voltages of the respective converters C1, C2, Cn are in correspondence with the assigned parameter record HB1, HB2, HBn.

This different assignment of parameter records HB1, HB2, HBn can also be recognized in FIG. 5b and FIG. 5c. FIGS. 5b and 5c show exemplary traces of the output signal V1, V2 of the first converter and the second converter.

In FIGS. 5a to 5c a PWM cycle lasts 12.5 μs. As the first converter C1 is assigned in the first PWM cycle the first parameter record HB1 and in the second PWM cycle the second parameter record HB2, the duty cycles of the output voltage V1 of the first converter in the first and the second PWM cycles are different. The trace of the output voltage V1 of the first converter repeats every two PWM cycles. The output voltage V2 of the second converter C2 is equal to the output voltage V1 of the first converter C1, but with an offset, in particular with the offset of one PWM cycle.

In an optional embodiment the converters C1, C2, Cn are synchronised. For instance every two PWM cycles there is a synchronising signal applied to the converters C1, C2, Cn.

Also the duty-cycles and/or the phase-shift angles of the control signals Si1, Si2, Si3, Si4 of the respective converters C1, C2, Cn may be defined by the parameter records HB1, HB2, HBn.

For instance, the converters C1, C2, Cn of the multi-level converter arrangement MLC each comprise a switching unit B1, B2, Bn with two half-bridge modules and each parameter record HB1, HB2, HBn defines a duty-cycles for the half-bridge modules of the respective converter C1, C2, Cn, wherein the duty-cycles of the half-bridge modules are different. Alternatively or additionally each parameter record HB1, HB2, HBn defines a phase shift angle for the respective half-bridge modules of the converters C1, C2, Cn, wherein the phase shift angles of the half-bridge modules are different.

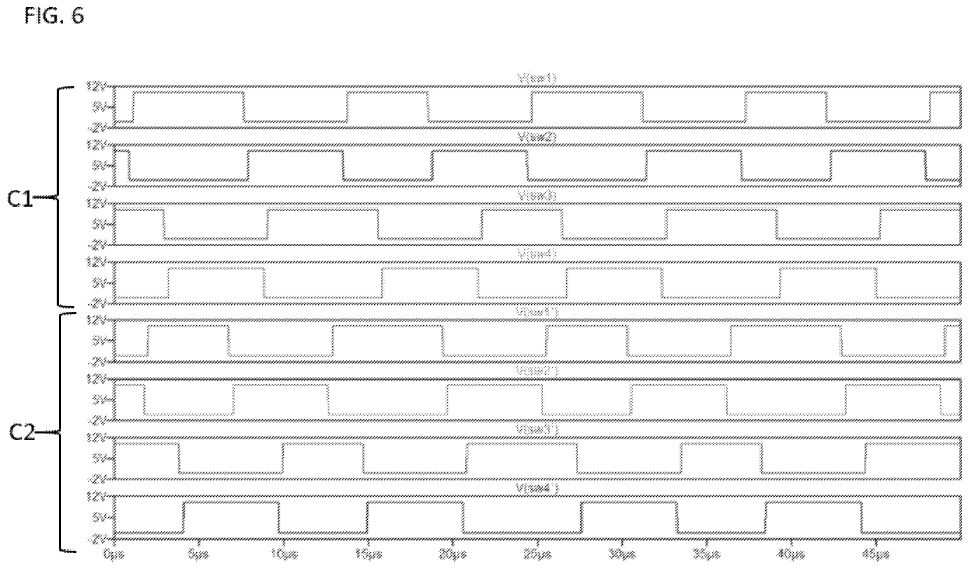

In the exemplary embodiment of FIG. 6 two converters are used to provide the output voltage Vcon of the multi-level converter arrangement MLC. FIG. 6 shows exemplary traces of switch pulses applied to the switches SW1, . . . , SW4 of the first converter C1 and the second converter C2, which cause the first converter C1 and the second converter to provide the output signals V1, V2 and finally the output voltage Vcon of the multi-level converter arrangement MLC shown in FIGS. 5a to 5c.

The following system parameters may be used:

| | |
|---|---|
| Operation frequency | [79 . . . 90 kHz] freq = 85 kHz |
| Pulse period | Tp = 1/freq |
| Duty cycle | [0 . . . 180 deg] D = 0.5 |
| On-Time | Ton = D*Tp |
| Off-Time | Toff = Tp − Ton |
| Dead-Time | Tdead[ns] |
| Phase C1 | [0 . . . 180 deg] phase1 = 0 . . . 0.5 |
| Phase C2 | [0 . . . 180 deg] phase2 = 0 . . . 0.5 |
| Phase 1 period | Tphase1 = phase1*Tp |
| Phase 2 period | Tphase2 = phase2*Tp |
| Delay time phase ½ | Tdelay = 0.5*(phase1 − phase2)*Tp |

Phase angels “Phase C1” and “Phase C2” are for example selected based on a Fourier's series optimization with minimizing selected harmonics and/or minimizing total distortion in the output quantities (voltage or current) as criterion for optimization.

In Table 2 for a wireless power transfer charging system applying a 3-level modulation, a 5-level modulation, 7-level modulation and a 9-level modulation the different harmonics are listed comparatively. The wireless power transfer charging system is for example configured to provide ii kW.

A normalized primary current (Norm. Pri. Curr) serves as a comparative value. As can be seen in Table 2, for example the 3^{rd} harmonic is reduced from 4.71E-02 (3-level modulation) to 0.656E-02 (5-level modulation) or 0.647E-02 (7-level modulation or 0.623E-02 (9-level modulation).

TABLE 2
Comparison of individual harmonics reduction

| | 3-level modulation | | 5-level modulation | | 7-level modulation | | 9-level modulation | |
|---|---|---|---|---|---|---|---|---|
| | | Norm. | | Norm. | | Norm. | | Norm. |
| Harmonic | Freq. | Pri. Curr. | Freq. | Pri. Curr. | Freq. | Pri. Curr. | Freq. | Pri. Curr. |
| Number | [Hz] | [p.u.] | [Hz] | [p.u.] | [Hz] | [p.u.] | [Hz] | [p.u.] |
| 1 | 8.41E+04 | 1.00E+00 | 8.34E+04 | 1.00E+00 | 8.29E+04 | 1.00E+00 | 8.30E+04 | 1.00E+00 |
| 2 | 1.68E+05 | 1.78E−05 | 1.67E+05 | 1.42E−05 | 1.66E+05 | 1.03E−05 | 1.66E+05 | 3.05E−05 |
| 3 | 2.52E+05 | 4.71E−02 | 2.50E+05 | 6.56E−03 | 2.49E+05 | 6.47E−03 | 2.49E+05 | 6.23E−03 |
| 4 | 3.36E+05 | 1.18E−04 | 3.34E+05 | 2.08E−04 | 3.31E+05 | 4.71E−05 | 3.32E+05 | 1.16E−05 |
| 5 | 4.21E+05 | 8.35E−02 | 4.17E+05 | 3.49E−02 | 4.14E+05 | 1.27E−02 | 4.15E+05 | 4.18E−03 |
| 6 | 5.05E+05 | 7.17E−05 | 5.00E+05 | 7.69E−05 | 4.97E+05 | 2.16E−05 | 4.98E+05 | 8.35E−06 |
| 7 | 5.89E+05 | 4.26E−03 | 5.84E+05 | 5.03E−03 | 5.80E+05 | 2.98E−03 | 5.81E+05 | 1.59E−03 |
| 8 | 6.73E+05 | 3.25E−05 | 6.67E+05 | 6.48E−05 | 6.63E+05 | 1.07E−05 | 6.64E+05 | 6.02E−06 |
| 9 | 7.57E+05 | 3.61E−03 | 7.51E+05 | 3.42E−03 | 7.46E+05 | 4.67E−03 | 7.47E+05 | 2.45E−03 |
| 10 | 8.41E+05 | 1.95E−05 | 8.34E+05 | 2.74E−05 | 8.29E+05 | 7.29E−06 | 8.30E+05 | 4.76E−06 |
| 11 | 9.25E+05 | 5.29E−03 | 9.17E+05 | 3.65E−03 | 9.11E+05 | 1.27E−03 | 9.13E+05 | 1.52E−03 |
| 12 | 1.01E+06 | 2.04E−05 | 1.00E+06 | 2.83E−05 | 9.94E+05 | 5.96E−06 | 9.95E+05 | 3.60E−06 |
| 13 | 1.09E+06 | 5.18E−03 | 1.08E+06 | 5.65E−03 | 1.08E+06 | 2.29E−03 | 1.08E+06 | 6.12E−04 |
| 14 | 1.18E+06 | 1.26E−05 | 1.17E+06 | 3.00E−05 | 1.16E+06 | 5.16E−06 | 1.16E+06 | 3.45E−06 |
| 15 | 1.26E+06 | 4.13E−03 | 1.25E+06 | 2.27E−03 | 1.24E+06 | 1.17E−03 | 1.24E+06 | 1.39E−03 |
| 16 | 1.35E+06 | 1.33E−05 | 1.33E+06 | 1.44E−05 | 1.33E+06 | 4.42E−06 | 1.33E+06 | 2.84E−06 |
| 17 | 1.43E+06 | 3.05E−03 | 1.42E+06 | 4.63E−04 | 1.41E+06 | 1.22E−03 | 1.41E+06 | 4.84E−04 |
| 18 | 1.51E+06 | 1.25E−05 | 1.50E+06 | 2.30E−05 | 1.49E+06 | 3.68E−06 | 1.49E+06 | 3.08E−06 |
| 19 | 1.60E+06 | 1.88E−03 | 1.59E+06 | 2.74E−04 | 1.57E+06 | 1.48E−03 | 1.58E+06 | 8.09E−04 |
| 20 | 1.68E+06 | 8.56E−06 | 1.67E+06 | 1.92E−05 | 1.66E+06 | 3.07E−06 | 1.66E+06 | 2.26E−06 |
| 21 | 1.77E+06 | 8.02E−04 | 1.75E+06 | 1.03E−03 | 1.74E+06 | 1.27E−03 | 1.74E+06 | 4.72E−04 |

In Table 3 a comparison of the Total Harmonic Distortion (THD) of a wireless power transfer charging system applying a 3-level modulation, a 5-level modulation, 7-level modulation and a 9-level modulation is provided.

TABLE 3
Harmonics reduction

| | Input | Output | | Voltage | Current |
|---|---|---|---|---|---|
| Converter | power | power | Efficiency | THD | THD |
| level N | [W] | [W] | [%] | [%] | [%] |
| 3 | 11360 | 9555 | 84 | 34.5 | 9.6 |
| 5 | 11411 | 9553 | 84 | 13.8 | 3.9 |
| 7 | 11505 | 9570 | 83 | 11.1 | 1.6 |
| 9 | 11532 | 9527 | 83 | 6.6 | 0.8 |

Compared to conventional three-level modulation, more degrees of freedom in N-level modulation allow a significant reduction of the distortion in the converter output voltage and current, as shown in Tables 3 and 4, while still maintaining similar efficiency irrespective of the number of converters used (Table 3).

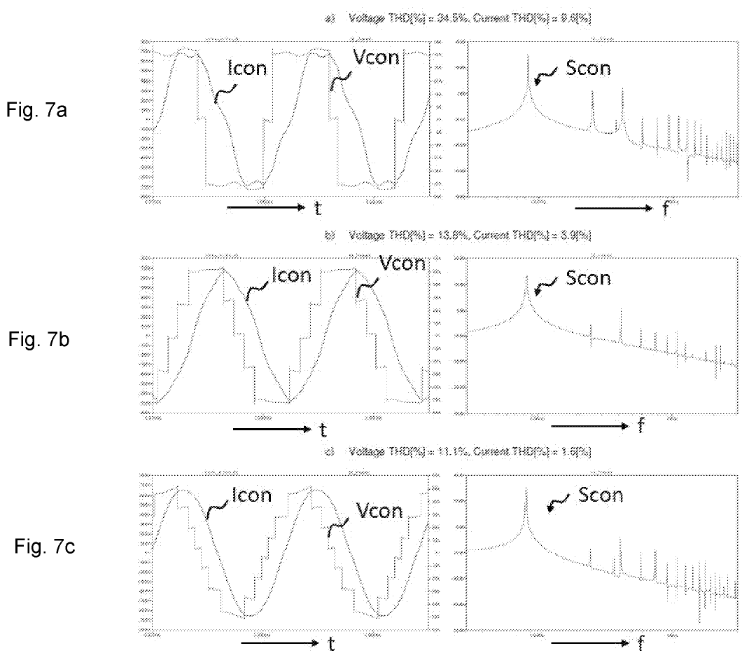

FIGS. 7a to 7d show voltage output traces and current output traces of a respective multi-level converter arrangement as well as the corresponding spectral analysis for the wireless power transfer system (FIG. 7a 3-level modulation, FIG. 7b 5-level modulation, FIG. 7c 7-level modulation and FIG. 7d 9-level modulation).

Furthermore, an increase in overall efficiency is most likely due to a reduction in copper and iron losses caused by higher frequency harmonics which have been eliminated as shown in Table 4. Table 4 shows the efficiency gain and the harmonic reduction under different operating conditions when the harmonic reduction mechanism is activated (ON) or deactivated (off).

TABLE 4
Efficiency gain and harmonics reduction

| Power in | Power Out | Voltage in | Voltage out | Harmonic | Harmonic | Field level | Efficiency | Efficiency |
|---|---|---|---|---|---|---|---|---|
| W | W | Vdc | Vdc | reduction | number | uT | % | gain |
| 320 | 249 | 50 | 24 | off | 3 | 0.4752 | 77.81% | 1.54% |
| 310 | 246 | 68 | 24 | ON | 3 | 0.1178 | 79.35% | |
| 320 | 249 | 50 | 24 | off | 5 | 0.0707 | 77.81% | 1.54% |
| 310 | 246 | 51 | 24 | ON | 5 | 0.0275 | 79.35% | |
| 320 | 249 | 50 | 24 | off | 9 | 0.0432 | 77.81% | 2.51% |
| 310 | 249 | 54 | 24 | ON | 9 | 0.0314 | 80.32% | |

In Table 4 the unity of the field level is given in micro Tesla (μT). The field level characterises the radiated emission level measured in close proximity to the WPT coils.

Although the invention has been illustrated and described in detail by means of the preferred embodiment examples, the present invention is not restricted by the disclosed examples and other variations may be derived by the skilled person without exceeding the scope of protection of the invention.

1.-13. (canceled)

14. A method for operating a wireless charger, wherein the wireless charger comprises a multi-level converter arrangement with a first converter and at least one further converter, each converter configured to receive a respective control signal vector and to provide a pulse-width-modulated converter output signal on its output terminals depending on the received control signal vector, and a power source resonator configured to wirelessly transmit power to a power capture resonator, wherein the multi-level converter arrangement is configured to provide a supply power to the power source resonator, the method comprising:
providing a set of parameter records;
assigning parameter records of the set of parameter records to individual converters; and
generating and providing, for each converter depending on an assigned parameter record, a control signal vector so that the multi-level converter arrangement provides the supply power with a desired signal waveform to the power source resonator,
wherein the set of parameter records depends on the desired signal waveform of the supply power provided by the multi-level converter arrangement,
wherein each parameter record defines a duty-cycle and/or a phase shift angle of the converter output signal, and
wherein the duty-cycles and/or the phase shift angles of at least two parameter records are different.

15. The method according to claim 14, wherein an assignment of the parameter records to the converters varies over time.

16. The method according to claim 14, wherein, for the multi-level converter arrangement with at least five levels, an assignment of the parameter records changes after every pulse-width-modulation cycle.

17. The method according to claim 14,
wherein at least one converter of the converters comprises a switching unit with two half-bridge modules,
wherein each parameter record defines a duty-cycle for a respective half-bridge modules of the converter, and wherein duty-cycles of the half-bridge modules are different and/or
wherein each parameter record defines a phase shift angle for the respective half-bridge modules of the converters, and wherein phase shift angles of the half-bridge modules are different.

18. The method according to claim 14, further comprising controlling a switching frequency of the converters such that an output voltage of the multi-level converter arrangement comprises a fundamental frequency between 79 kHz and 90 kHz.

19. The method according to claim 14, further comprising selecting the parameter records of the converters based on a Fourier's series optimization with minimizing selected harmonics and/or minimizing total distortion as criterion for optimization.

20. An apparatus, wherein the apparatus is configured to:
operate a wireless charger;
provide a set of parameter records;
assign parameter records of the set of parameter records to individual converters of a multi-level converter arrangement of the wireless charger; and
generate and provide, for each converter depending on an assigned parameter record, a control signal vector so that the multi-level converter arrangement provides a supply power with a desired signal waveform to a power source resonator of the wireless charger,
wherein the set of parameter records depends on the desired signal waveform of the supply power provided by the multi-level converter arrangement,
wherein each parameter record defines a duty-cycle and/or a phase shift angle of the converter output signal, and
wherein the duty-cycles and/or the phase shift angles of at least two parameter records are different.

21. A wireless charger system comprising:
the apparatus according to claim 20; and
the wireless charger comprising:
the multi-level converter arrangement with a first converter and at least one further converter, each converter configured to receive a respective control signal vector and to provide a pulse-width-modulated converter output signal on its output terminals depending on the received control signal vector,
the power source resonator configured to wirelessly transmit power to a power capture resonator.

22. The wireless charger system according to claim 21, wherein the multi-level converter arrangement comprises N levels and M converters, and wherein N is a positive integer greater than 3 or equal to 3, and M=(N−1)/2.

23. The wireless charger system according to claim 22, wherein the multi-level converter arrangement comprises K isolation transformers, and wherein K=M−1.

24. The wireless charger system according to claim 23, wherein the isolation transformers are arranged between the multi-level converter arrangement and the power source resonator.

25. The wireless charger system according to claim 21, wherein at least one converter of the converters comprises a switching unit with two half-bridge modules.

26. The wireless charger system according to claim 21, wherein the wireless charger comprises a power correction module configured to supply a direct voltage to at least two converters.

27. A wireless power transfer system comprising:
the wireless charger system according to claim 21;
the power capture resonator; and
a rectifier configured to be coupled to a load.
